(19) United States
(12) Patent Application Publication
(10) Pub. No.: US 2015/0056028 A1
(43) Pub. Date: Feb. 26, 2015

(54) CUTTING PLATE HAVING FLANK FACES AND CONTACT FACES ON THE PERIPHERAL GEOMETRY

(71) Applicant: CeramTec GmbH, Plochingen (DE)

(72) Inventor: Raouf Ben Amor, Wipperfurth (DE)

(73) Assignee: CeramTec GmbH, Plochingen (DE)

(21) Appl. No.: 14/387,617

(22) PCT Filed: Mar. 28, 2013
(86) PCT No.: PCT/EP13/56680

§ 371 Date: Sep. 24, 2014

(30) Foreign Application Priority Data
Mar. 30, 2012 (DE) 10 2012 205 199.6

(51) Int. Cl. B23B 27/16

(52) U.S. Cl. CPC B23B 27/1611; B23B 2200/12
USPC 407/113

(57) ABSTRACT

A cutting plate (9) having flank faces (5) for installing for machining workpieces having a top clamping face (1) and a bottom clamping face (2) and a peripheral geometry that connects the clamping faces (1, 2) and blades (cutting corners (4) and cutting edges (8) arranged at the transition from each clamping face (1, 2) to the peripheral geometry with positive flank faces (5) arranged below the blades (4, 8). The flank faces are recessed relative to the blades (4, 8) creating a relief angle that is positive on both sides (3). A single contact face (3) is arranged on each side (10) of the peripheral geometry and has the largest width (B1) thereof on center plane (7) of the peripheral geometry. Contact face (3) shrinks from the center plane (7) to cutting edges (8) and has the smallest width (B2) in the area of cutting edges (8).

The invention relates to a cutting plate according to the preamble of claim 1.

A negative ceramic cutting plate having a double-positive flank face is known from the generic patent WO 2008/155331 A1. This cutting plate is used for installation in carrier tools for machining workpieces. The cutting plate has a top side and a bottom side and a peripheral geometry connecting the top side and the bottom side. Cutting edges and cutting corners are arranged at the transition from the top side and the bottom side to the peripheral geometry. The peripheral geometry has a peripheral positive flank face on both sides beneath the cutting edges and cutting corners, said flank face being recessed with respect to the cutting edges and cutting corners, so that a positive flank face is created on both sides. A collar that is elevated with respect to the lowest points on the flank faces is arranged between two opposing flank faces with respect to the top side and the bottom side on the peripheral geometry, with the surface area of the collar serving as a contact face in carrier tools. The elevated collar is referred to below as a contact face.

The object of the present invention is to optimize this cutting plate according to the prior art with a double-positive flank face. The goal is to maximize the contact face in the sense of stable fixation of the cutting plate (indexable insert). On the other hand, the contact face should be designed so that the contact face does not come in contact with the workpiece with increased wear on the blade. This would result in a negative effect on the machining process and damage to the component. The term “blade” refers to the cutting edges and cutting corners. When a cutting plate is mentioned below, it always refers to an indexable insert. An indexable insert is preferably made of a ceramic, but may also be made of hard metal, cermet, CBN or PCBN.

The contact face should, if possible, cover the entire peripheral geometry from the clamping face at the top to the clamping face at the bottom, but this is of course impossible, because then there would not be a positive flank face. At the same time, the contact face is the contact face of the cutting plate in the holder tool. The length of the contact faces, i.e., the contact faces in the holder seat is important for securing the cutting plate to prevent it from twisting in the plane parallel to the clamping face planes. The longer the length of the contact faces, the more stable is the fixation in the area of the radius and/or in the area of the blades. However, it is important to be sure that no contact faces stand in the way in the offset of the blades as a result of wear.

According to the invention, this object is achieved by the fact that a contact face is arranged on each side of the peripheral geometry, said contact face having its greatest width in the center plane of the peripheral geometry and shrinking starting from the center plane to the cutting edges and having its smallest width in the area of the cutting edges.

The contact face is set back in the area of the cutting edges, so that the distance from the cutting corner to the contact face is maximized. At the same time, the contact face is lengthened in the central region on the central plane between the clamping faces, so as to yield a contact face of the maximum length. In the area of the clamping face, the contact face is attached, so that the advantages of a double-positive cutting plate for a maximum cutting depth can be achieved. For this reason, the width of the support face shrinks toward the clamping face and/or toward the cutting edges. This results in a positive rake angle over a rather large cutting depth.

In a preferred embodiment, two flank faces on the peripheral geometry that are opposite one another with respect to the center plane merge into one another at the lowest point in the center plane of the cutting plate, so that no contact face is provided on the cutting corners. The flank face is therefore at its maximum in this region.

Alternatively, the contact faces of two neighboring sides merge into one another at the cutting corners. This produces a peripheral contact face and therefore optimal support in the carrier tool.

The contact faces are recessed in the area of the cutting edges and therefore positive blades are formed over the entire width of the cutting plate. Therefore, the contact faces do not come in contact with the cutting edges. The positive cutting edge in this embodiment is optimized with respect to length.

In one embodiment, the contact faces merge into the cutting edges in the area of the cutting edges. In this embodiment, the support in the area of the cutting edges is optimized.

In one embodiment, the blades and the contact faces are of the same height. In another embodiment, the blades and the contact faces are of different heights.

In an advantageous embodiment, the contact face is rectangular, preferably square, as seen from above, having contact face corners, such that two opposing contact face corners are arranged in the center plane of the cutting plate and the other two contact face corners are in contact with the cutting edges.

The invention is explained in greater detail below on the basis of three figures.

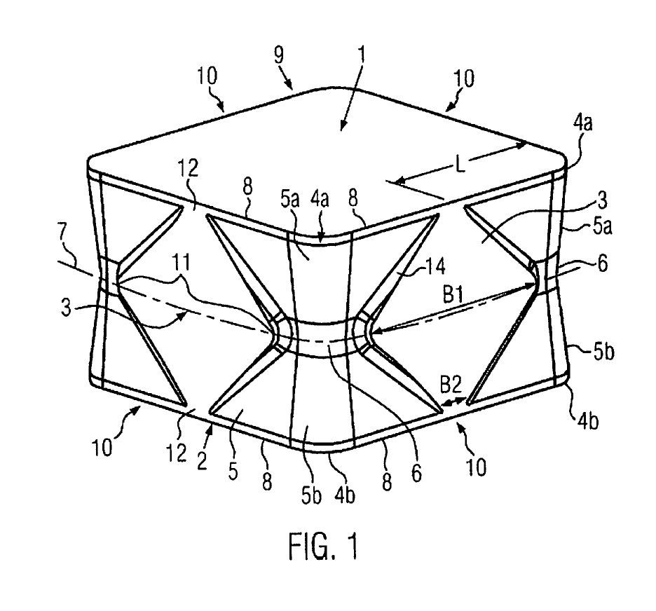

FIG. 1 shows a cutting plate 9 according to the invention, in this case a square cutting plate, having a top side on which a top clamping face 1 is arranged and a bottom side on which a bottom clamping face 2 is arranged. Clamping recesses may also be created on the clamping faces 1, 2. The clamping face 1 is arranged parallel to the clamping face 2. The two clamping faces 1, 2 are connected via a peripheral geometry, which comprises four sides 10 with this cutting plate and/or indexable insert. All four sides 10 have the same peripheral geometry.

At the transition from the clamping faces 1, 2 to the peripheral geometry, there are cutting corners 4 and cutting edges 8. On the whole, the cutting plate has eight cutting corners 4. Beneath the cutting corners 4 and cutting edges 8, there are flank faces 5, which are recessed with respect to the cutting corners 4 and cutting edges 8. There is a single contact face 3 on the peripheral geometry of each of the four sides of this cutting plate. This contact face 3 is an elevation, whose surface forms the actual contact face 3. For the sake of simplicity, the term contact face 3 is used for this elevation.

The cutting plate 9 has a center plane 7, which runs parallel to the clamping faces 1, 2 and is arranged centrally between the two clamping faces 1, 2. The contact face 3 on each side 10 has its greatest width B1 in the center plane 7 and extends to the cutting edge 8 in the embodiment according to FIG. 1, where the width of the contact face 3 reduces steadily toward the cutting edge 8. The contact face 3 has its smallest width B2 on the cutting edge 8. The contact face 3 may have any geometric shape. The contact face illustrated in FIGS. 1 to 3 is designed to be rectangular or square and has four contact face corners 11, 12. Two contact face corners 11 are provided in the center plane 7 and two additional contact face corners 12 are provided on the cutting edges 8. All sides of the contact face 3 lead into the flank faces 5 by way of a slope 14.

In the area of the cutting edges 4a, 4b, flank faces 5a, 5b lead in the direction of the center plane 7 and open into a lowest point 6 in the center plane 7. The area of the cutting corners 4 and/or 4a, 4b is designed without a contact face in the embodiment according to FIG. 1.

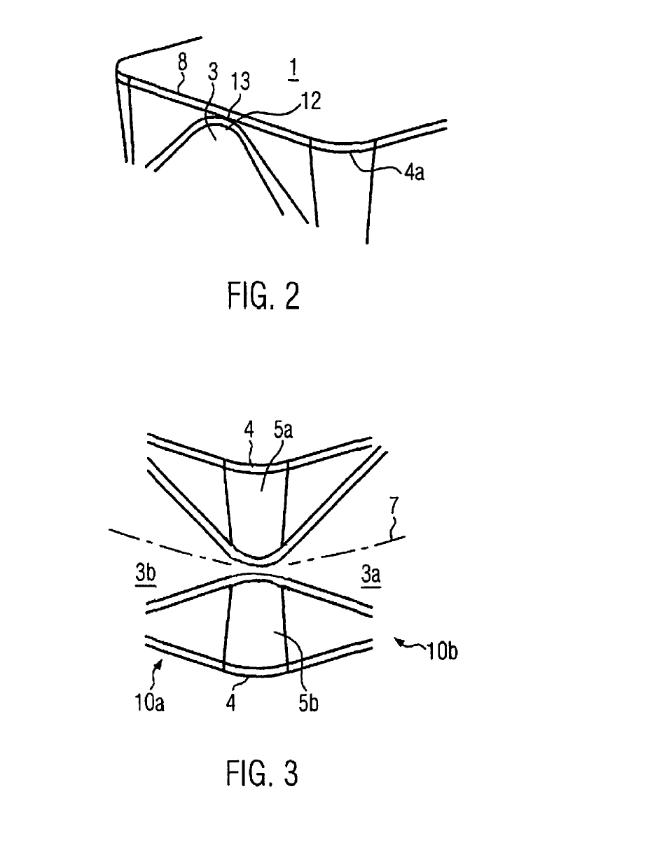

FIG. 2 shows an alternative design of a cutting plate 9 according to the invention, where the contact face corner 12 is arranged at a distance 13 from the cutting edge 8. In other words, the contact face is recessed in the area of the cutting edge 8, so that positive cutting edges 8 are formed over the entire width of the cutting plate. The positive cutting edge 8 here is optimized with regard to its length, in contrast with the embodiment according to FIG. 1.

FIG. 3 shows the area around the cutting edge 4 then an alternative embodiment where the contact faces 3a, 3b of two contiguous sides 10a, 10b of a cutting plate merge into one another in the center plane 7. In this way, the contact face is designed to be run peripherally in the center plane 7, so that the support is optimized.

In one embodiment, the invention is thus characterized in that the contact face 3 is set back in the area of the cutting edges 8, so that the distance L (see FIG. 1) from the cutting corner 4 to the contact face 3 is maximized. At the same time, the contact face 3 is lengthened in the central region in the center plane 7, resulting in a contact face (3) of maximum length (B1). In the area of the cutting face, the contact face 3 is mounted in such a way that the advantages of a double-positive indexing insert for a maximum cutting depth can be achieved. For this reason, the width B of the contact face 3 shrinks in the direction of the clamping face 1 and/or 2 and/or in the direction of the cutting edges 8. The result is a positive rake angle over a rather large cutting depth.

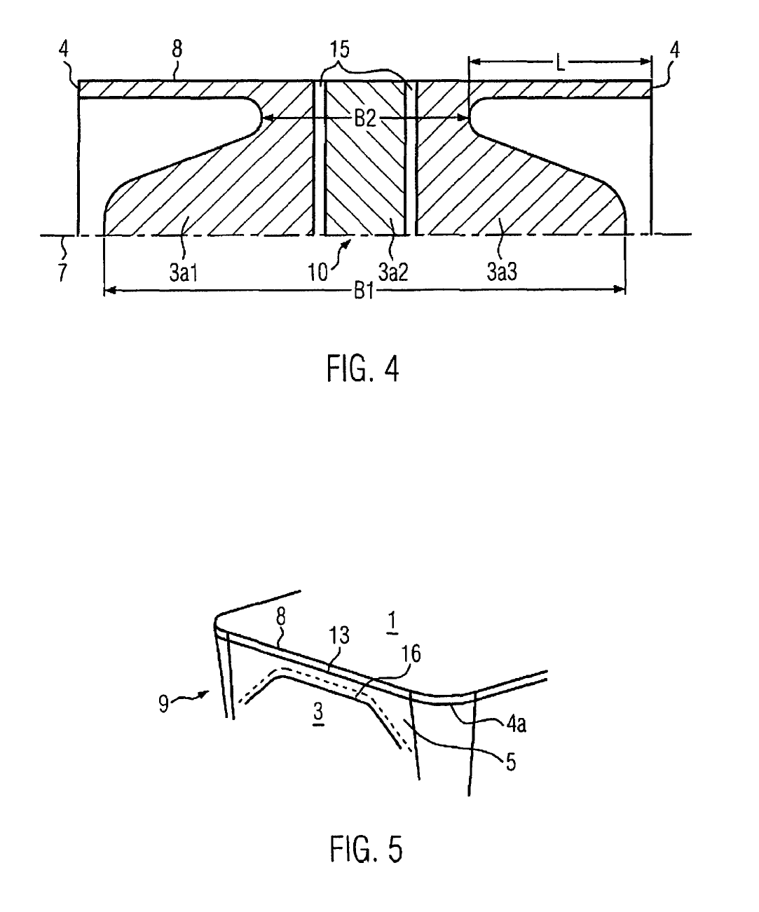

FIGS. 1 to 3 show one embodiment, in which the contact face 3 is a single uninterrupted face. FIG. 4 shows a view of only one side 10 or half of a side of an alternative embodiment, wherein the contact face consists of three partial faces, namely contact faces 3a1, 3a2 and 3a3, all of which are at the same height. The contact face 3a1 is separated from the contact face 3a2 as well as the contact face 3a2 being separated from the contact face 3a3 by a gap 15. The same reference numerals denote the same parts. The center plane is labeled with reference numeral 7, as is also the case in the other figures. Again in this embodiment, the maximum width B1 of the contact faces is located in the center plane. The contact faces have the smallest width B2 in the area of the cutting edges 8.

The height refers to the distance from a plane passing through the longitudinal axis of the cutting plate. The surface of the contact face or the contact faces is arranged parallel to this plane. This is true of all the embodiments.

FIG. 5 shows an alternative embodiment of a cutting plate 9 according to the invention, where, in contrast to the embodiments according to FIGS. 1 and 2, the contact face 3 is designed as a contact face edge 16 in the area of the cutting edges 8. The contact face edge 16 is arranged at a distance 13 from the cutting edge 8. The flank faces 5 in this embodiment are very large, which is optimal for a few application cases.

The cutting plate according to the invention thus has contact faces 3 and flank faces 5 on its peripheral geometry.
a) Flank faces 5 are situated beneath the blades 4.
b) Two opposing flank faces 5a, 5b on the peripheral geometry with respect to the center plane 7 merge into one another at their lowest point 6 in the center plane 7 of the cutting plate. At this lowest point 6, there is thus no contact face 3 (see FIG. 1).
c) On the peripheral geometry, a contact face 3, having its greatest width B1 in the center plane 7 of the peripheral geometry and shrinking starting from the center plane 7 to the clamping faces 1, 2 and/or cutting edges 8, is arranged between two opposing cutting edges 8 on one side 10 (see FIG. 1).
d) The contact faces 3, the cutting edges 8 and the cutting corners 4 of one side are preferably situated in the same plane.

1.-9. (canceled)

10. A cutting plate for installation in carrier tools for machining workpieces comprising:
a top clamping face on a top side thereof;
a bottom clamping face on its bottom side thereof, wherein the cutting plate has a peripheral geometry connecting the top clamping face and the bottom clamping face;
blades at a transition from the respective clamping face to the peripheral geometry;
positive flank faces arranged beneath the blades which are recessed with respect to the blades such that a relief angle that is positive on both sides is created; and
a contact face that is elevated with respect to lowest points on the flank faces arranged on each side of the peripheral geometry;
wherein the contact face arranged on each side of the peripheral geometry has its greatest width (B1) in a center plane of the peripheral geometry and shrinks from the center plane to the cutting edges and has its smallest width (B2) in the area of the cutting edges.

11. The cutting plate according to claim 10, wherein two opposing flank faces with respect to the center plane on the peripheral geometry merge into one another at their lowest point in the center plane of the cutting plate, so that there is no contact face on the cutting corners.

12. The cutting plate according to claim 10, wherein the contact faces of two neighboring sides merge into one another at the cutting corners.

13. The cutting plate according to claim 10, wherein the contact faces are recessed in the area of the cutting edges and thereby form positive blades over the entire width of the cutting plate.

14. The cutting plate according to claim 10, wherein the contact faces merge into the cutting edges in the area of the cutting edges.

15. The cutting plate according to claim 10, wherein the blades and the contact faces have the same height.

16. The cutting plate according to claim 11, wherein the blades and the contact faces have the same height.

17. The cutting plate according to claim 12, wherein the blades and the contact faces have the same height.

18. The cutting plate according to claim 10, wherein the blades and the contact faces have different heights.

19. The cutting plate according to claim 11, wherein the blades and the contact faces have different heights.

20. The cutting plate according to claim 12, wherein the blades and the contact faces have different heights.

21. The cutting plate according to claim 10, wherein the contact faces are designed to be rectangular as seen from above and have contact face corners such that two opposing contact face corners are arranged in the center plane of the cutting plate and the two other contact face corners are in contact at the cutting edges.

22. The cutting plate according to claim 11, wherein the contact faces are designed to be rectangular as seen from above and have contact face corners such that two opposing contact face corners are arranged in the center plane of the cutting plate and the two other contact face corners are in contact at the cutting edges.

23. The cutting plate according to claim 12, wherein the contact faces are designed to be rectangular as seen from above and have contact face corners such that two opposing contact face corners are arranged in the center plane of the cutting plate and the two other contact face corners are in contact at the cutting edges.

24. The cutting plate according to claim 13, wherein the contact faces are designed to be rectangular as seen from above and have contact face corners such that two opposing contact face corners are arranged in the center plane of the cutting plate and the two other contact face corners are in contact at the cutting edges.

25. The cutting plate according to claim 14, wherein the contact faces are designed to be rectangular as seen from above and have contact face corners such that two opposing contact face corners are arranged in the center plane of the cutting plate and the two other contact face corners are in contact at the cutting edges.

26. The cutting plate according to claim 15, wherein the contact faces are designed to be rectangular as seen from above and have contact face corners such that two opposing contact face corners are arranged in the center plane of the cutting plate and the two other contact face corners are in contact at the cutting edges.

27. The cutting plate according to claim 18, wherein the contact faces are designed to be rectangular as seen from above and have contact face corners such that two opposing contact face corners are arranged in the center plane of the cutting plate and the two other contact face corners are in contact at the cutting edges.

28. The cutting plate according to claim 10, wherein the contact face is a single uninterrupted face or consists of a plurality of partial faces, all of which are at the same height.

29. The cutting plate according to claim 11, wherein the contact face is a single uninterrupted face or consists of a plurality of partial faces, all of which are at the same height.

30. The cutting plate according to claim 12, wherein the contact face is a single uninterrupted face or consists of a plurality of partial faces, all of which are at the same height.

31. The cutting plate according to claim 13, wherein the contact face is a single uninterrupted face or consists of a plurality of partial faces, all of which are at the same height.

32. The cutting plate according to claim 14, wherein the contact face is a single uninterrupted face or consists of a plurality of partial faces, all of which are at the same height.

33. The cutting plate according to claim 15, wherein the contact face is a single uninterrupted face or consists of a plurality of partial faces, all of which are at the same height.

34. The cutting plate according to claim 18, wherein the contact face is a single uninterrupted face or consists of a plurality of partial faces, all of which are at the same height.

35. The cutting plate according to claim 21, wherein the contact face is a single uninterrupted face or consists of a plurality of partial faces, all of which are at the same height.
